(19) United States
(12) Patent Application Publication
(10) Pub. No.: US 2004/0035629 A1
(43) Pub. Date: Feb. 26, 2004

(54) Straddle-type all-terrain vehicle with mechanically-actuated brake system

(76) Inventors: Vincent Morin, Canton de Brompton (CA); Brian Mastine, Richmond (CA)

Correspondence Address: PILLSBURY WINTHROP, LLP, P.O. BOX 10500, MCLEAN, VA, 22102, US

(21) Appl. No.: 10/442,182

(22) Filed: May 21, 2003

Related U.S. Application Data
(60) Provisional application No. 60/381,806, filed on May 21, 2002.
(60) Provisional application No. 60/412,807, filed on Sep. 24, 2002.

(51) Int. Cl. B60K 17/356

(52) U.S. Cl. 180/244; 180/336

(57) ABSTRACT

An ATV is provided including a frame structure and a power unit coupled to the frame structure and including a rotatable output shaft extending therefrom. A brake system is coupled to the output shaft and includes a friction member fixedly coupled to the output shaft. A brake pad member is movable relative to the friction member. A lever arm member is pivotably mounted to the power unit between proximal and distal end portions of the lever arm member, the proximal end portion being in engagement with the brake pad member to effect movement thereof. A brake actuating structure is configured to be manually movable and has a wedge member thereon. The wedge member is in engagement with the distal end portion of the lever arm member to effect pivotal movement thereof upon manual displacement of the brake actuating structure.

The present application claims priority to U.S. Provisional Application Serial No. 60/381,806, which was filed on May 21, 2002, and also U.S. Provisional Application Serial No. 60/412,807, which was filed on Sep. 24, 2002, the entirety of both applications are hereby incorporated into the present application by reference.

### BACKGROUND OF THE INVENTION

1. Field of the Invention

The present invention relates to straddle-type all-terrain vehicles and, more particularly, to a brake system for the same.

2. Description of Related Art

Current brake systems employ the use of cables and/or hydraulic systems. While these systems have performed satisfactorily for their intended purposes, such systems can be expensive and complicated. Moreover, a cable system may be prone to stretching out, while a hydraulic system may be sensitive to temperature conditions, such as where the fluid filled pipes expand, which may affect the reliability and the sensibility of the brake system.

Accordingly, a need has developed in the art to provide a brake system which is more reliable, less expensive and which provides constant braking over time.

### SUMMARY OF THE INVENTION

One embodiment of the present invention provides an ATV including a frame structure and a power unit coupled to the frame structure and including a rotatable output shaft extending therefrom. The ATV includes a brake system coupled to the output shaft and configured to apply a braking force thereon. The brake system includes a friction member fixedly coupled to the output shaft to rotate therewith. The friction member defines a frictional surface thereon. A brake pad member is movable relative to the friction member into and out of frictional engagement with the frictional surface to generate the braking force. A lever arm member is pivotably mounted to the power unit between proximal and distal end portions of the lever arm member. The proximal end portion is in engagement with the brake pad member to effect movement thereof. A brake actuating structure is configured to be manually movable and has a wedge member thereon. The wedge member is in engagement with the distal end portion of the lever arm member to effect pivotal movement thereof upon manual displacement of the brake actuating structure and thereby effect movement of the brake pad member relative to the friction member.

Another aspect of the present invention provides a brake system for an ATV including a frame structure, a power unit coupled to the frame structure and having a rotatable output shaft extending therefrom. The brake system includes a friction member fixedly coupled to the output shaft to rotate therewith. The friction member defines a frictional surface thereon. A brake pad member is movable relative to the friction member into and out of frictional engagement with the frictional surface to generate the braking force. A lever arm member is pivotably mounted to the power unit between proximal and distal end portions of the lever arm member. The proximal end portion is in engagement with the brake pad member to effect movement thereof. A brake actuating structure is configured to be manually movable and has a wedge member thereon. The wedge member is in engagement with the distal end portion of the lever arm member to effect pivotal movement thereof upon manual displacement of the brake actuating structure and thereby effect movement of the brake pad member relative to the friction member.

Yet another embodiment of the present invention provides a power unit for an ATV including a frame structure. The power unit includes an engine and a housing configured to couple to the frame of the ATV. An output shaft is rotatably coupled to the engine and a friction member is fixedly coupled to the output shaft to rotate therewith. The friction member defines a frictional surface thereon. A brake pad member is movable relative to the friction member into and out of frictional engagement with the frictional surface to generate braking force. A lever arm member is pivotably mounted to the power unit between proximal and distal end portions of the lever arm member. The proximal end portion is in engagement with the brake pad member to effect movement thereof. A brake actuating structure is configured to be manually movable and has a wedge member thereon. The wedge member is in engagement with the distal end portion of the lever arm member to effect pivotal movement thereof upon manual displacement of the brake actuating structure and thereby effect movement of the brake pad member relative to the friction member.

These and other aspects of the present invention will be described with reference to the following detailed description of preferred illustrated embodiments.

### BRIEF DESCRIPTION OF THE DRAWINGS

FIG. 1 is a perspective view of an ATV according to principles of the present invention shown without body panels and other components attached thereto;

FIG. 2 is a perspective view of a contemplated rear wheel drive assembly for the ATV of FIG. 1;

FIG. 3 is a perspective view of a contemplated power unit for the ATV of FIG. 1 shown without a brake system attached thereto;

FIG. 4 is a partial perspective view of the power unit of FIG. 3 shown without a drive sprocket attached thereto;

FIG. 5 is a detailed perspective view of the power unit of FIG. 3 shown with the drive sprocket and brake system attached thereto;

FIG. 6 is a perspective view of the brake system according to principles of the present invention;

FIG. 7 is a side view of the brake system of FIG. 6;

FIG. 8 is a rear view of the brake system of FIG. 6;

FIG. 9 is a detailed perspective view of a contemplated attachment of the brake system to the power unit;

FIG. 10 is a perspective view of a spacer member;

FIGS. 11-12 are plan views of the spacer member of FIG. 10;

FIG. 13 is a perspective view of a brake caliper assembly;

FIGS. 14A-14C are plan views of the brake caliper assembly of FIG. 13;

FIGS. 15A-15C are plan views of a lever arm member;

FIG. 16 is a detailed perspective view of the brake system;

FIG. 17A is a perspective view of a wedge member;

FIGS. 17B-17C are plan views of the wedge member of FIG. 17A;

FIG. 18 is a cross-sectional view taken about line XVIII-XVIII in FIG. 1; and

FIG. 19 is a detailed view of a portion of the brake system indicated in FIG. 6.

### DETAILED DESCRIPTION OF ILLUSTRATED PREFERRED EMBODIMENTS OF THE INVENTION

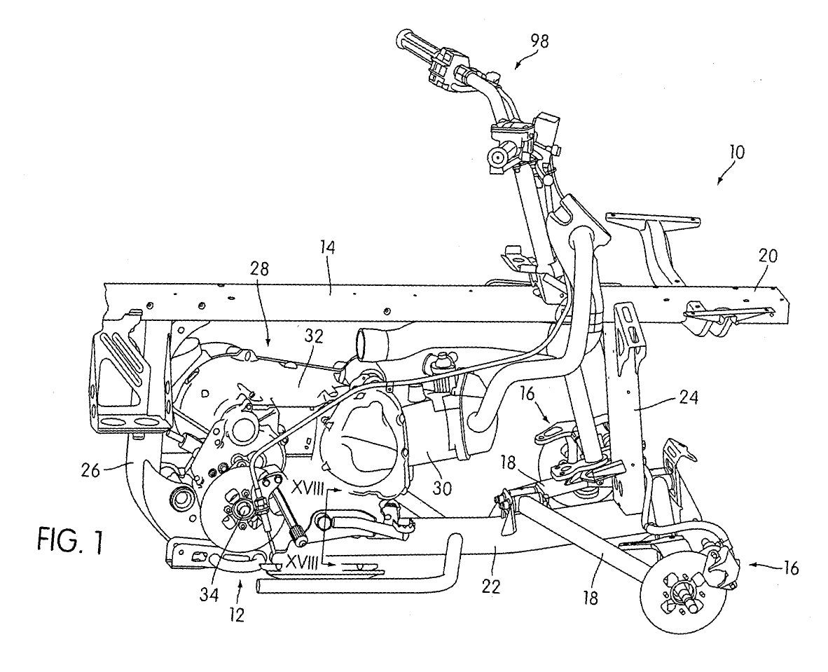

FIG. 1 shows an ATV 10 according to principles of the present invention including a brake system 12. The ATV 10 is shown in FIG. 1 without body panels, a rear wheel drive assembly, and other components so as to better illustrate details of the ATV 10. As shown, the ATV 10 includes a frame structure 14 having front steerable wheel assemblies 16 pivotably coupled thereto via respective suspension arms 18. It is contemplated that the suspension arms 18 may be of a type disclosed in U.S. Provisional Application of Lachapelle filed May 2, 2002 entitled “Suspension Arm Arrangement for Straddle-Type All-Terrain Vehicle”, incorporated herein by reference in its entirety. Of course, the suspension arms 18 may be of any conventional design. As also shown, the frame structure 14 may include upper and lower generally horizontally extending frame members 20, 22 interconnected at forward and rearward portions thereof with cross members 24, 26, respectively. It is contemplated that the frame structure 14 may be of one type disclosed in U.S. application of Rasidescu et al., Ser. No. 09/824,878, filed Apr. 4, 2001, which is incorporated herein by reference in its entirety. It is also contemplated that the frame structure 14 may be, alternatively, of any conventional frame design.

The ATV 10 includes a power unit, indicated at 28, which may include an internal combustion engine 30 and a transmission assembly 32. The engine 30 and transmission assembly 32 may be of any possible design. For example, the engine 30 may be of a two-stroke, single cylinder type and the transmission assembly 32 may be of a continuously variable transmission (CVT) type. However, any other type of engine and/or transmission may be used. The power unit 28 has an output shaft 34 extending therefrom which is, in the illustrated embodiment, rotatable by the engine 30 via the transmission assembly 32. As shown, the output shaft 34 extends laterally with respect to the frame structure 14 and rotates about a rotational axis generally normal to the frame structure 14.

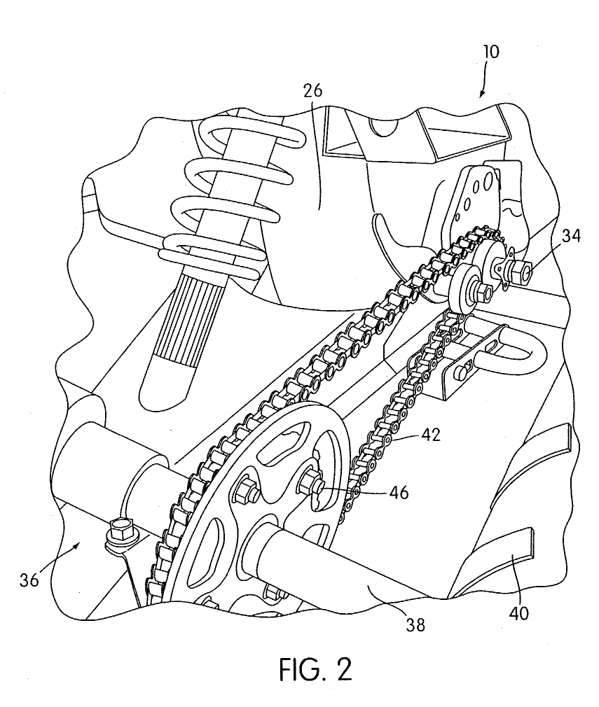

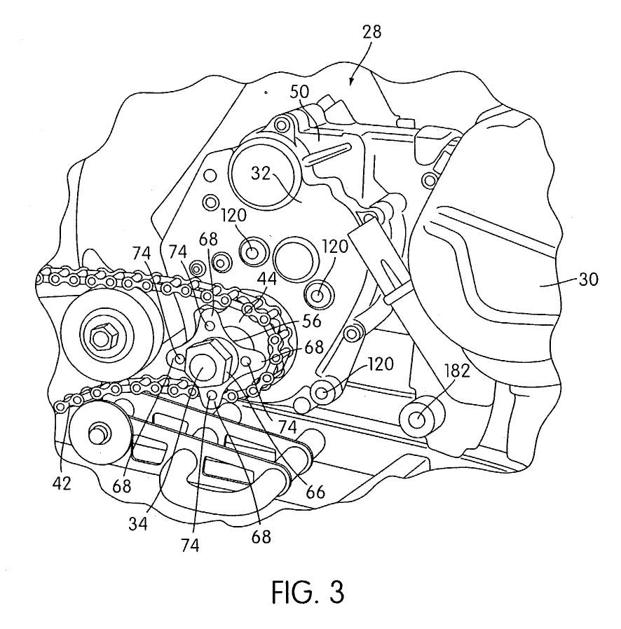

As shown in FIG. 2, the ATV 10 may include a rear drive assembly 36 having at least one axle 38 coupled to a rear wheel assembly 40. The rear drive assembly 36 may be coupled to the output shaft 34 with a chain structure 42. As shown in FIG. 3, in this case, the output shaft 34 has fixedly connected thereto a drive sprocket 44 that drivingly engages the chain structure 42. Referring back to FIG. 2, the rear drive assembly 36 includes a driven sprocket 46 that is coupled to the axle 38 to transfer power from the power unit 28 to the wheel assembly 40.

It is also contemplated that the power unit 28 may be coupled to the rear drive assembly 36 via a drive shaft (not shown). In this case, it may be preferable for the transmission assembly 32 to be arranged such that the output shaft 34 extends generally longitudinally relative to the frame structure 14. The drive shaft in this case may be coupled to the output shaft 34 via a universal joint or splined joint. Additionally, the rear drive assembly 36 may include a differential to translate rotation of the drive shaft into rotation of the one or more axles 38.

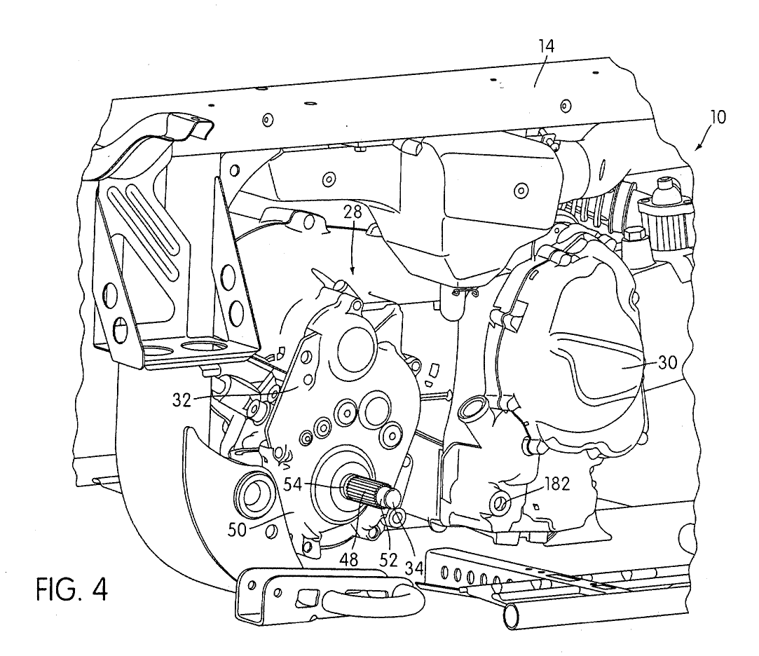

As shown in FIG. 4, the output shaft 34 includes an external splined surface 48 that extends axially from a point adjacent a housing 50 of the power unit 28 to a threaded portion 52 on an outer most portion of the output shaft 34. Referring back to FIG. 3, the drive sprocket 44 has an axially extending opening therethrough, which defines an internal splined surface (not shown). The drive sprocket 44 is disposed on the output shaft 34 such that the external splined surface 48 of the output shaft 34 engages with the internal splined surface of the opening within the drive sprocket 44 to thereby non-rotatably couple the drive sprocket 44 to the output shaft 34. As shown in FIG. 4, the output shaft 34 includes a radially outwardly extending shoulder structure 54 that prevents axial movement of the drive sprocket 44 toward the power unit 28.

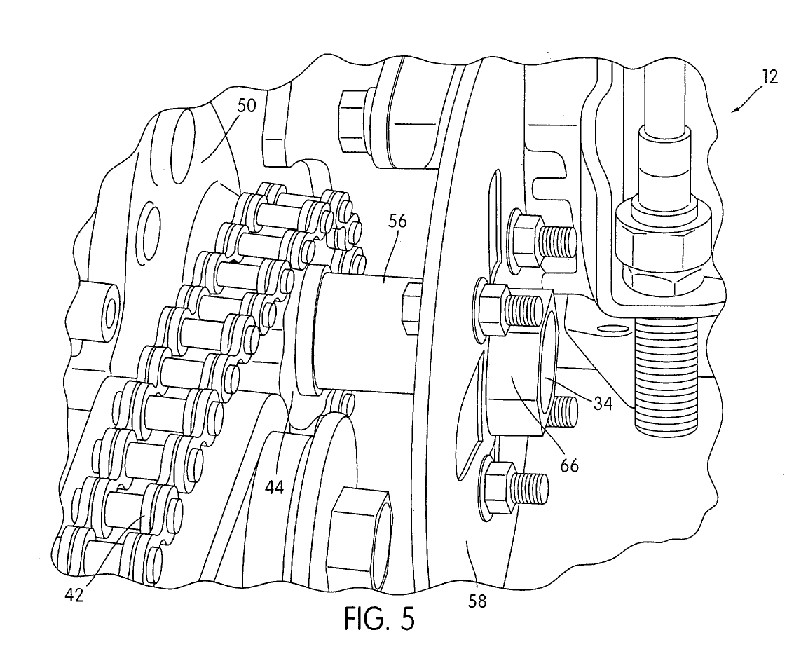

As shown in FIG. 5, the brake system 12 may include a hub member 56 mounted on the output shaft 34 adjacent and outwardly of the drive sprocket 44. The hub member 56 may have a brake disk 58 rigidly coupled thereto.

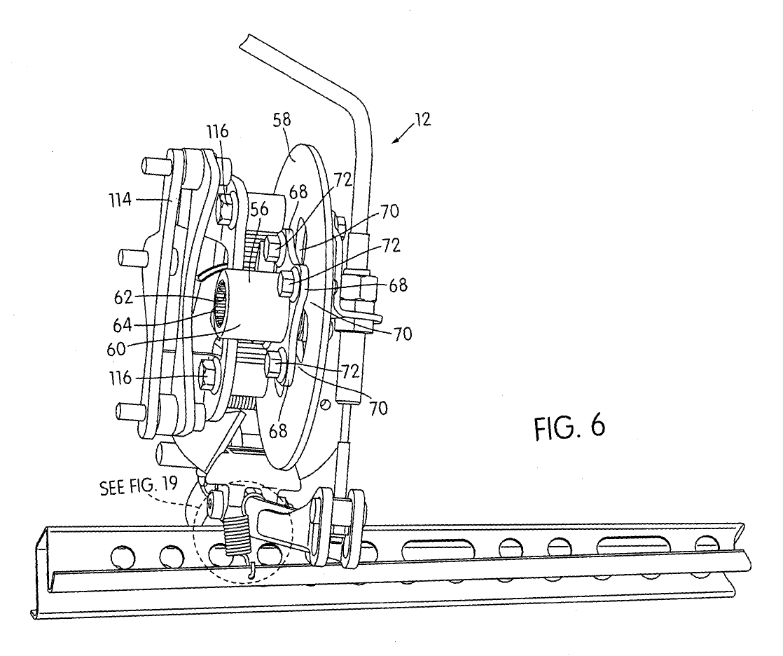

In particular, as shown in FIG. 6, the hub member 56 includes a cylindrical connecting portion 60 that provides an axially extending opening 62 therein defining an interior splined surface 64.

The output shaft 34 is received within the opening 62 and the splined surface 64 of the hub member 56 cooperates with the external splined surface 48 of the output shaft 34 to non-rotatably couple the hub member 56 and output shaft 34 to one another. As shown in FIGS. 3 and 5, the hub member 56 is axially retained on the output shaft 34 by a nut 66 threadedly engaged with the threaded portion 52 of the output shaft 34. Accordingly, the hub member 56 is axially disposed on the output shaft 34 between the drive sprocket 44 and the nut 66. Referring to FIGS. 3 and 6, the hub member 56 additionally includes a plurality of lobes or ears 68 extending radially outwardly from an axially outward end portion thereof. The hub member 56 is shown in the illustrated embodiment having four lobes 68, however, any number may be utilized.

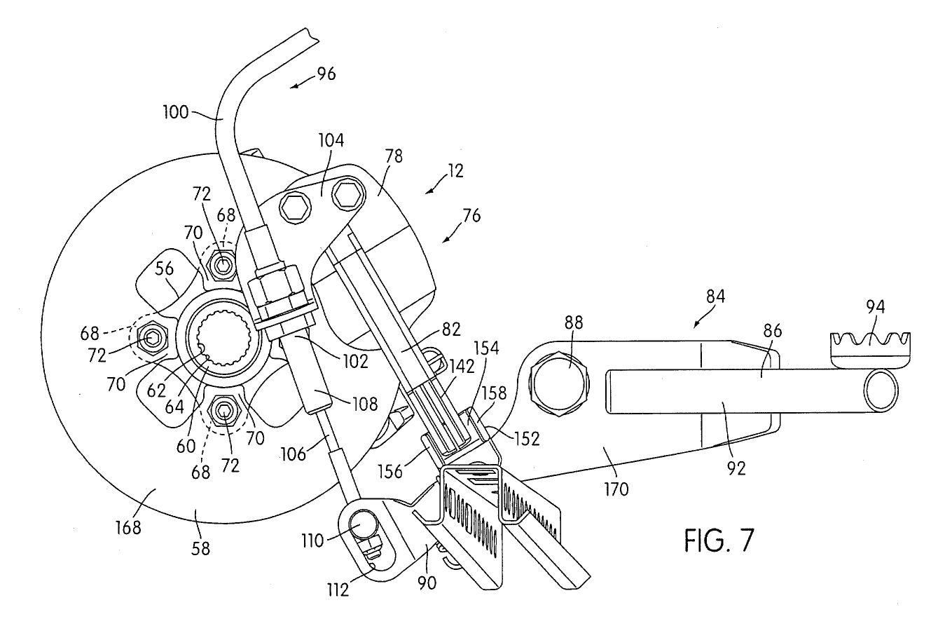

As shown in FIGS. 6 and 7, the brake disk 58 preferably includes a plurality of radially inwardly extending connecting portions 70 corresponding to the plurality of lobes 68 on the hub member 56, which partially coextend respective lobes 68 so as to allow the connection of the brake disk 58 to the hub member 56 with fasteners 72. The fasteners 72 may be in the form of bolts and nuts threadedly engaged therewith extending through openings within the lobes 68 and connecting portions 70. FIG. 3 shows such openings formed within the lobes 68, indicated at 74. In the above-described manner, or in any other suitable manner, the brake disk 58 may be non-rotatably coupled to the output shaft 34.

FIG. 7 shows the brake system 12 including the brake disk 58 coupled to the hub member 56 and a caliper assembly 76. The caliper assembly 76 is fixedly mounted to the housing 50 of the power unit 28, as will be discussed in greater detail below. The caliper assembly 76 includes a rigid housing structure 78, e.g., made of cast aluminum, within which a pair of spaced brake pad members 80, shown in FIG. 8, are slidably mounted so as to be capable of sliding and/or pivoting movement toward and away from one another. It is contemplated that the caliper assembly 76 may include biasing structure 144 (FIG. 13) to bias the brake pad members away from one another (ie., away from the brake disk 58 disposed therebetween).

A pair of lever arm members 82 are pivotably mounted to the housing structure 78. The lever arm members 82 pivot about respective axes extending generally perpendicularly to the sliding movement of the brake pad members 80. The brake system 12 also includes a brake actuating structure 84, which is shown in the form of a brake pedal 86. The brake pedal 86 may be pivotably mounted to the housing 50 of the power unit 28 via a pivot bolt 88. The brake pedal 86 may also include a generally rearwardly extending actuating portion 90, which is disposed rearwardly of the pivot bolt 88 (i.e., rearwardly of the pivot axis of the brake pedal 86). The brake pedal 86 also includes a forward manually engageable portion 92, which may include a cleat structure 94 thereon, which is disposed forwardly of the pivot bolt 88 (i.e., forwardly of the pivot axis of the brake pedal 86). With this arrangement, when a user depresses the forward manually engageable structure 92, the rearward actuating portion 90 is correspondingly raised. The actuating portion 90 is coupled to the lever arm members 82, as will be discussed in detail below, so as to effect movement of the lever arm members 82 upon depression of the manually engageable portion 92 to thereby bring the brake pad members 80 into engagement with surfaces of the brake disk 58 and, thus, generate a braking force.

Additionally, the brake system 12 may include an alternate brake actuating structure 96 including a hand brake mechanism 98, shown in FIG. 1, coupled to the actuating portion 90 of the brake actuating structure 84 via a cable assembly 100. An end portion 102 is rigidly coupled to the housing structure 78 of the caliper assembly 76 with a mounting bracket 104. The cable assembly 100 includes a sliding cable element 106 slidably disposed within a sheathing 108. The cable element 106 is moved within the sheathing 108 by manual manipulation of the hand brake mechanism 98. A distal end of the cable element 106 has fixedly coupled thereto a connecting element 110, which is configured to be received within a slot 112 formed within the actuating portion 90 of the brake actuating structure 84. With this arrangement, the actuating portion 90 may be pivoted upward about the pivot bolt 88 by manual manipulation of the hand brake mechanism 98, however, upon manual depression of the manually engageable structure 92 of the brake pedal 86, the actuating portion 90 is correspondingly pivoted and the connecting element 110 is not moved due to the slot 112 within the actuating portion 90.

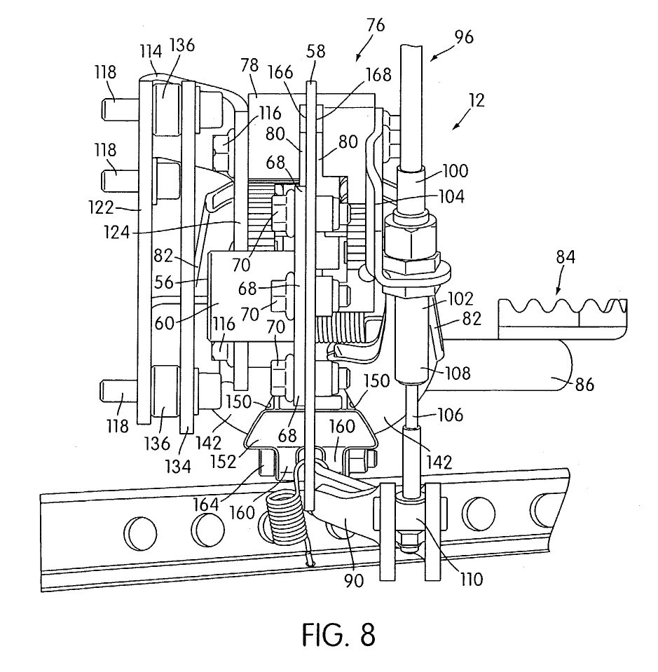

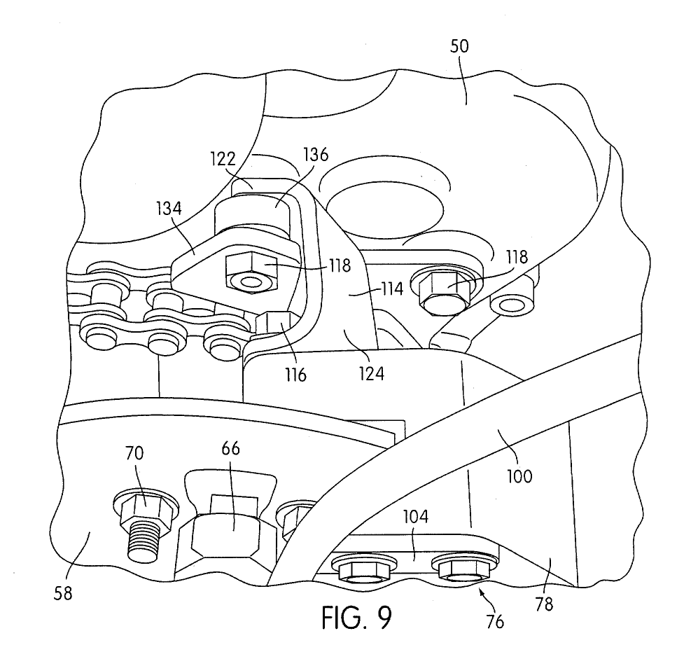

As shown in FIGS. 8 and 9, the brake system 12 may include a spacer bracket 114 fixedly connected to the housing structure 78 of the caliper assembly 76 with fasteners 116, such as bolts. The spacer bracket 114 is also fixedly connected to the housing 50 of the power unit 28, as shown in FIG. 9. For example, the spacer bracket 114 may be secured to the housing 50 with fasteners 118, such as bolts. FIG. 3 shows contemplated locations for threaded openings 120 within the housing 50 within which the fasteners 118 threadedly engage to secure the spacer bracket 114 to the housing 50.

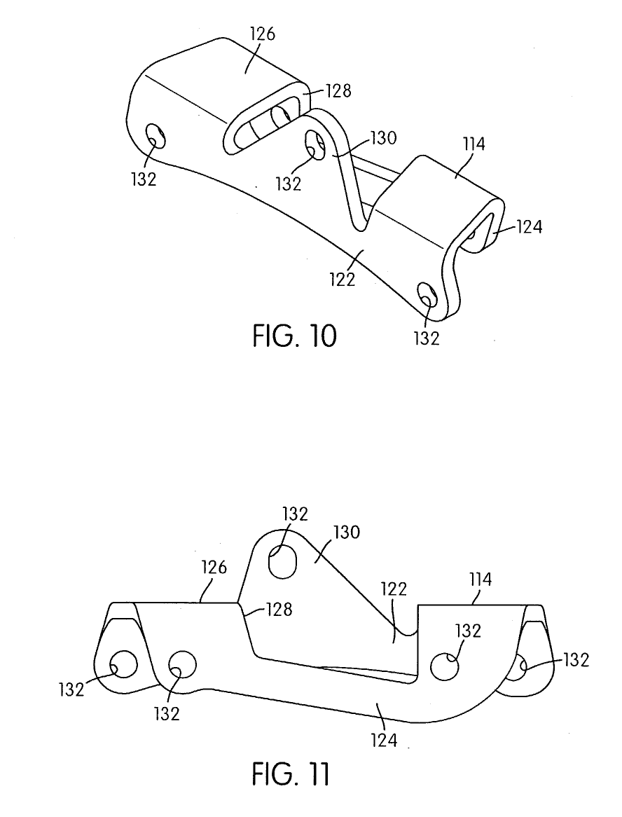

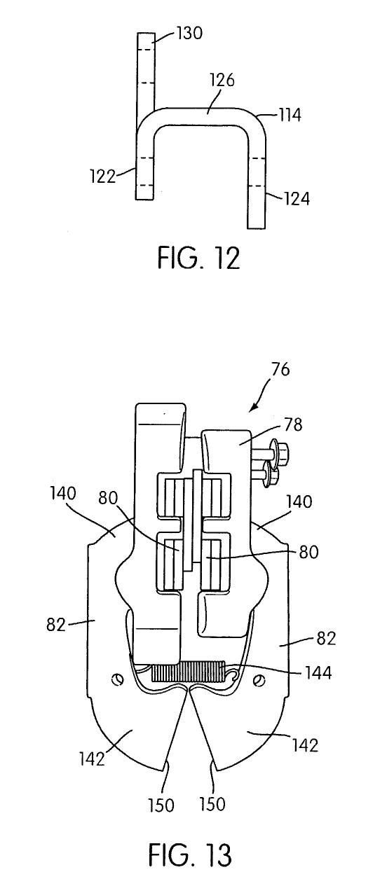

FIGS. 10-12 show the spacer bracket 114 in greater detail. As shown, the spacer bracket 114 includes a pair of spaced, generally parallel side wall members 122, 124. The side wall members 122, 124 are interconnected by a transverse wall member 126. As shown in FIGS. 10 and 11, the transverse wall member 126 has an opening 128 formed therein. Additionally, the side wall member 122 includes an outwardly extending flange portion 130. Furthermore, each of the side wall members 122, 124 and the flange portion 130 has openings 132 formed therein to allow the spacer bracket 114 to be mounted to the housing 50 and housing structure 78. In particular, referring back to FIG. 9, the side wall member 122 is fixedly mounted to the housing 50 with fasteners 118 and the caliper assembly 76 is fixedly mounted to the side wall member 124 with fasteners 116. Referring to FIGS. 8 and 9, a chain guide 134 may be disposed between the side wall members 122, 124 and secured in position with fasteners 118 and spacer members 136.

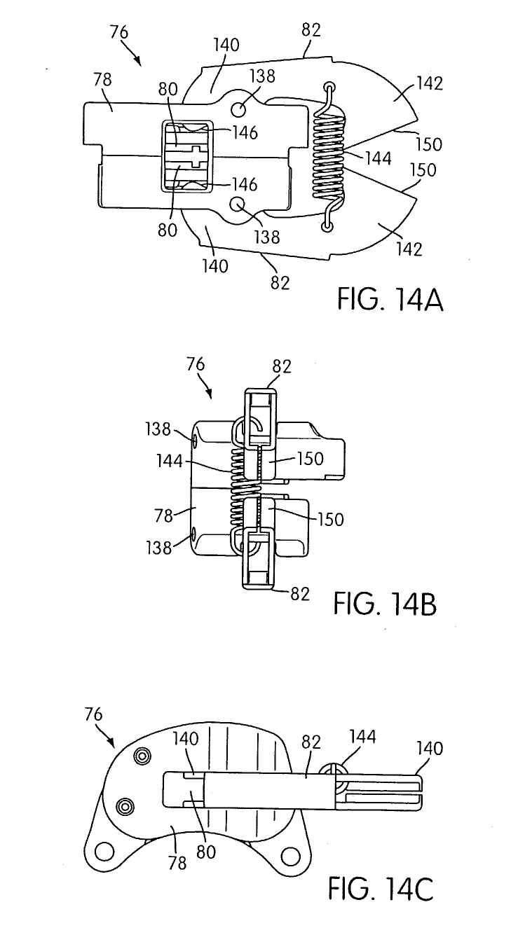

As shown in FIG. 13, the caliper assembly 76 includes the pair of lever arm members 82 coupled thereto so as to actuate the pair of brake pad members 80. In particular, referring to FIGS. 14A-14C, each of the lever arm members 82 is pivotably coupled to the housing structure 78 of the caliper assembly 76 via a respective pair of pivot pin structures 138. Each of the lever arm members 82 has a proximal end portion 140 configured to abut respective brake pad member 80. Each lever arm member 82 also has a distal end portion 142 opposite the distal end portion 140. The lever arm members 82 are pivotably movable about the pivot pin structures 138 at locations adjacent the proximal end portions 140 and between the proximal and distal end portions 140, 142. In this manner, outward movement of the distal end portion 142 (about the pivot pin structures 138) effects inward movement of the proximal end portions 140, thus effecting linear displacement of the brake pad members 80. The distal end portions 142 of the lever arm members 82 may be biased toward one another with the biasing structure 144, such as a tension spring to maintain a spaced relation of the brake pad members 80. The lever arms 82 may be made from forged steel.

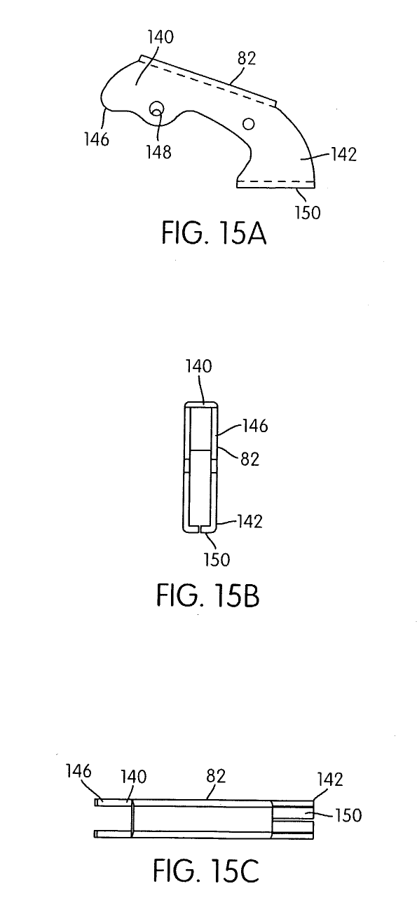

As shown in FIGS. 15A-15C, each of the proximal end portions 140 of the lever arm members 82 defines a generally transversely extending arcuate cam service 146 thereon configured to abut the respective brake pad member 80. Between the proximal and distal end portions 140, 142, the lever arm member 82 provides an opening 148 therein through which the respective pivot pin structure 138 extends to allow for the pivotal movement of the lever arm members 82. Furthermore, the distal end portions 142 of the lever arm members 82 define inclined slide surfaces 150.

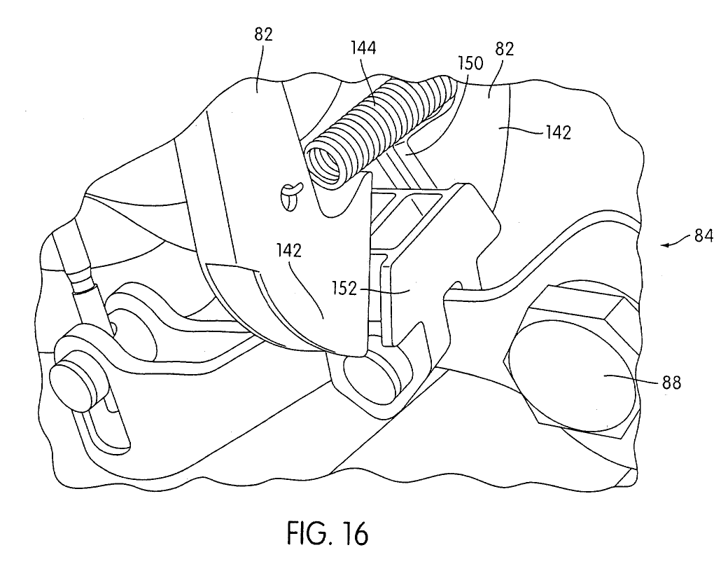

Referring back to FIGS. 7 and 8, the brake actuating structure 84 includes a wedge member 152 mounted to the actuating portion 90. The wedge member 152 is preferably formed of plastic, e.g., nylon, or Delrin. The caliper assembly 76 and brake actuating structure 84 are respectively arranged such that the wedge member 152 is disposed between the distal end portions 142 of the lever arm members 82. In particular, as shown in FIG. 16, the wedge member 152 is disposed between the distal end portions 142 of the lever arm members 82 and is engaged with respective inclined slide surfaces 150 thereof.

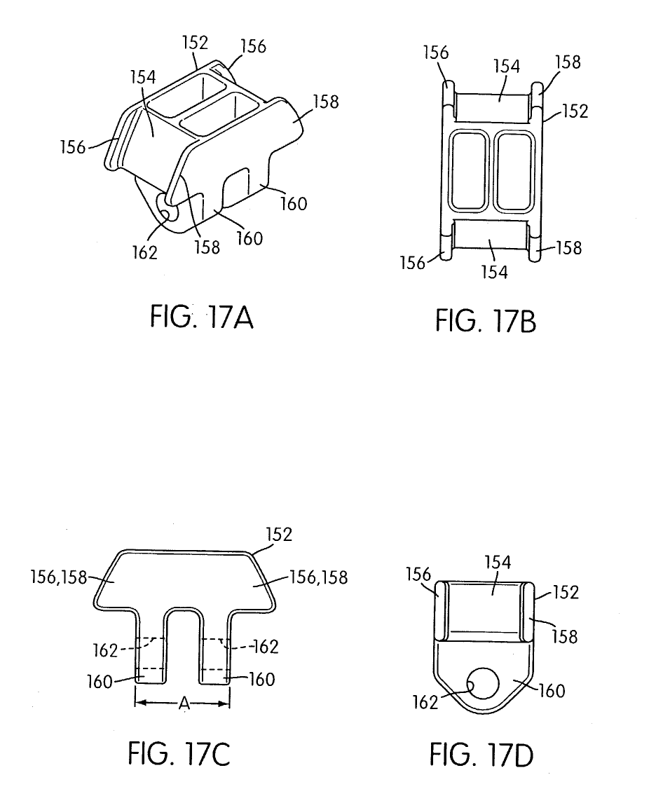

As shown in FIGS. 17A-17D, the wedge member 152 defines a pair of inclined wedge surfaces 154, which slidingly engage with respective inclined slide surfaces 150 of the lever arm members 82. Retaining wall members 156, 158 are disposed on respective sides of the lever arm members 82 (see FIG. 7) so as to retain the inclined slide surfaces 150 and engagement with the inclined wedge surfaces 154. Additionally, the wedge member 152 includes a pair of depending leg structures 160, each having an opening 162 formed therein. As shown in FIG. 8, the leg structures 160 are disposed on respective sides of the actuating portion 90 to secure the wedge member 152 thereto with a fastener 164, such as a bolt and nut, extending through the openings 162 and the actuating portion 90. The wedge member is mounted so as to be slidable in the direction of the arrows A shown in FIG. 17C, to facilitate alignment of the wedge member and the correspondingly engaging surfaces of the lever arm members 82.

Referring to FIGS. 7 and 8, upward pivotal movement of the actuating portion 90 (affected either by manual depression of the brake pedal 86 or manual retraction of the cable element 106) affects relative sliding movement between the wedge member 152 and the lever arm members 82. Consequently, the inclined wedge surfaces 154 slide upwardly along the inclined slide surfaces 150. The inclined configuration of the wedge surfaces 154 affect outward movement of the distal end portions 152 of the lever arm members 82 during the relative sliding movement between the wedge member 152 and the lever arm members 82. As discussed previously, as the distal end portions 142 are moved outwardly, the proximal end portions 140 are moved inwardly and correspondingly move the brake pad members 80 inwardly therewith. As the brake disk 58 is disposed between the brake pad members 80, manual depression of the brake pedal 86 or manual retraction of the cable element 106 affects frictional engagement of the brake pad members 80 with corresponding friction surfaces 166, 168 of the brake disk 58.

The wedge member causes actuation of the brake assembly in a predictable manner because, for example, there is very little “play” between the wedge member and the corresponding surfaces of the lever arm members. Also, the brake system is reliable and cost efficient since there are only a few parts. Moreover, the brake system can be used with vehicles other than ATVs, such as motorcycles.

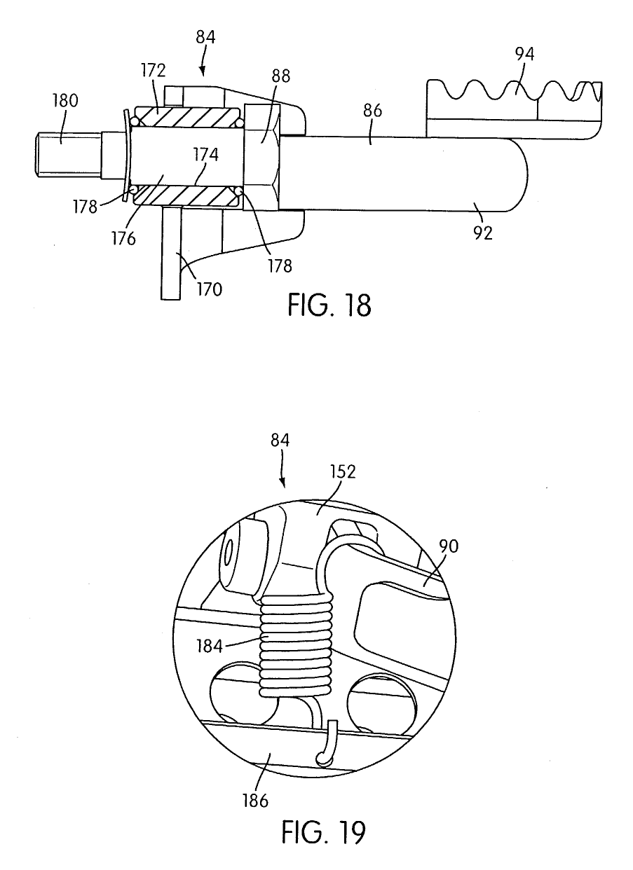

As shown in FIG. 18, the brake actuating structure 84 includes a lever arm structure 170, which provides a generally cylindrical general structure 172 thereon. The general structure 172 is formed with a central opening therein, which defines a cylindrical journaling surface 174 therein. The pivot bolt 88 is disposed within the opening of the general structure 172 and defines a pivot surface 176 thereon. The cylindrical journaling surface 174 slidably engages with the pivot surface 176 to allow pivotal movement of the journal structure 172 relative to the pivot bolt 88. Opposite axial ends of the journal structure 172 may be formed with recesses having respective sealing structures 178 therein to prevent dirt and debris from entering between the surfaces 174, 176. The pivot bolt 88 also includes a threaded portion 180, which threadedly engages with a threaded opening 182 within the housing 50 of the power unit 28, shown in FIGS. 3 and 4.

Moreover, the brake pedal 86 can be mounted directly to the power unit, e.g., the crankcase. Therefore, the engine can be shipped in a completely assembled state, with the brake pedal 86 and the disk already attached to the power unit, so connection to the frame of the ATV is facilitated.

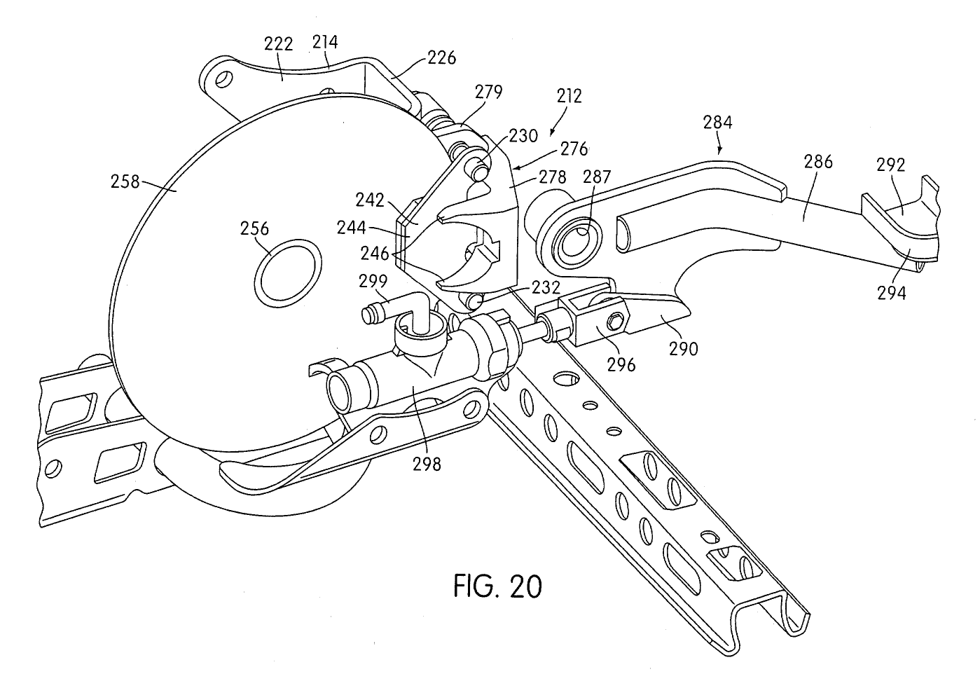

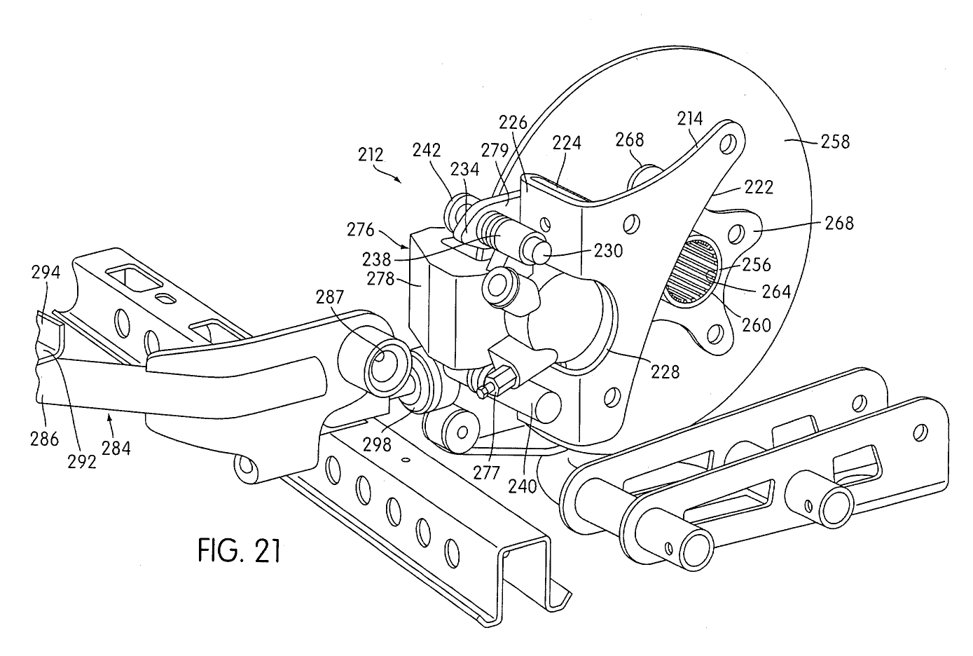

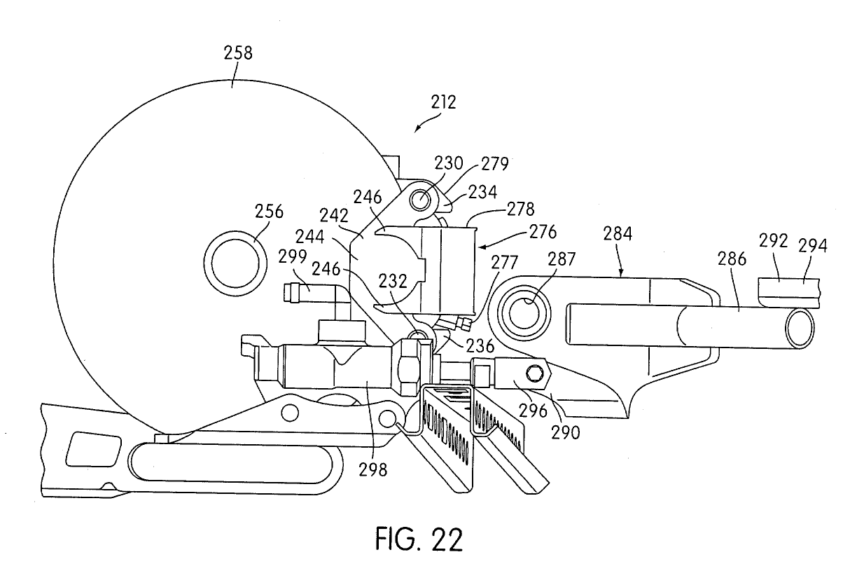

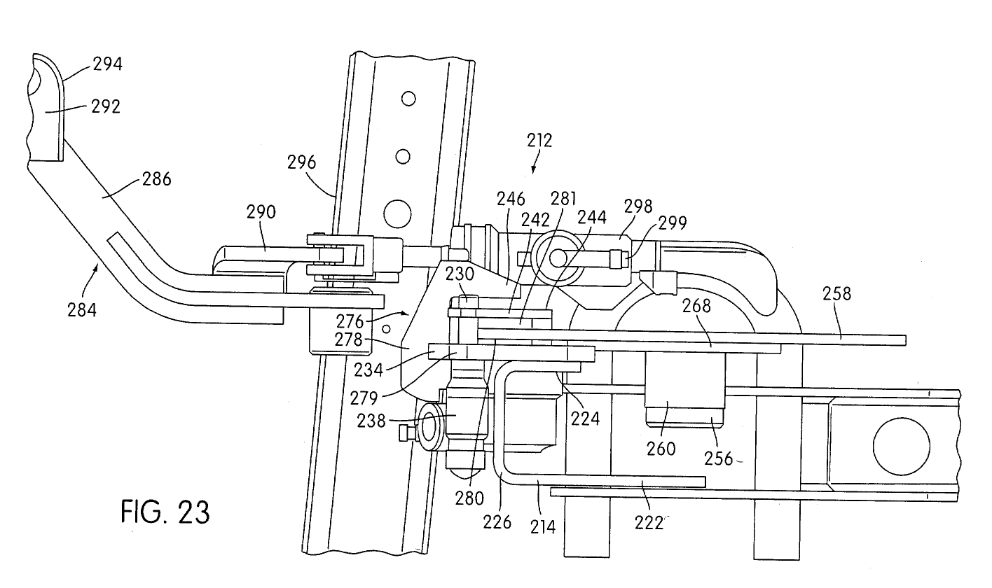

As shown in FIG. 19, the brake system 12 may include a biasing structure 184 such as a tension spring, to resiliently bias the brake actuating structure 84 in a brake releasing direction (i.e., in a direction opposite to that direction in which the brake actuating structure 84 moves to engage the brake). In particular, the biasing structure 184 may be connected between the actuating portion 90 of a brake actuating structure 84 and a frame member 186.

While the principles of the present invention have been made clear in the illustrative embodiments set forth above, it will be apparent to those skilled in the art that various modifications may be made to the structure, arrangement, proportion, elements, materials, and components used in the practice of the invention.

What is claimed is:

1. An ATV comprising:
a frame structure;
a power unit coupled to the frame structure and including a rotatable output shaft extending therefrom;
a brake system coupled to the output shaft and configured to apply a braking force thereon, the brake system including;
a friction member fixedly coupled to the output shaft to rotate therewith, the friction member defining a frictional surface thereon;
a brake pad member movable relative to the friction member into and out of frictional engagement with the frictional surface to generate the braking force;
a lever arm member pivotably mounted to the power unit between proximal and distal end portions of the lever arm member, the proximal end portion being in engagement with the brake pad member to effect movement thereof;
a brake actuating structure configured to be manually movable and having a wedge member thereon, the wedge member being in engagement with the distal end portion of the lever arm member to effect pivotal movement thereof upon manual displacement of the brake actuating structure and thereby effect movement of the brake pad member relative to the friction member.

2. An ATV according to claim 1, wherein the brake system includes a pair of brake pad member movable into and out of frictional engagement with the friction member.

3. An ATV according to claim 2, wherein the friction member is a brake disk having a pair of opposing outwardly facing frictional surface thereon, the pair of brake pad members being disposed on respective sides of the brake disk to engage respective frictional surfaces thereof.

4. An ATV according to claim 3, wherein the brake system includes a caliper assembly within which the brake pad members are movably mounted.

5. An ATV according to claim 4, wherein the brake system includes a pair of lever arm members, each of the lever arm members being pivotably mounted to the caliper assembly and each of the lever arm members having proximal end portions in engagement with respective brake pad members and distal end portions opposite the proximal end portions.

6. An ATV according to claim 5, wherein the wedge member is made of plastic and disposed between the distal end portions of the pair of lever arm members.

7. An ATV according to claim 6, wherein each of the distal end portions defines an inclined slide surface thereon that abut respective inclined wedge surfaces defined on the wedge member such that, as the wedge member advances and retreats along the distal end portions, the distal end portions are pivotably moved outwardly and inwardly, respectively, thereby moving the proximal end portions and the brake pad members inwardly and outwardly, respectively.

8. An ATV according to claim 7, wherein the power unit includes a substantially rigid housing structure.

9. An ATV according to claim 8, wherein the brake actuating structure is pivotably mounted to the housing structure.

10. An ATV according to claim 9, wherein the brake actuating structure includes a brake pedal attached thereto to allow manual manipulation of the brake actuating structure by a user's foot.

11. An ATV according to claim 9, wherein the brake actuating structure has coupled thereto a cable assembly coupled to a hand brake assembly to allow manual manipulation of the brake actuating structure by a user's hand.

12. An ATV according to claim 8, wherein the brake caliper assembly includes a housing thereof fixedly coupled to the housing of the power unit via a spacer member disposed between and fixedly connected to the housing of the power unit and housing of the caliper assembly.

13. A brake system for an ATV including a frame structure, a power unit coupled to the frame structure and having a rotatable output shaft extending therefrom, the brake system comprising:
a friction member fixedly coupled to the output shaft to rotate therewith, the friction member defining a frictional surface thereon;
a brake pad member movable relative to the friction member into and out of frictional engagement with the frictional surface to generate the braking force;
a lever arm member pivotably mounted to the power unit between proximal and distal end portions of the lever arm member, the proximal end portion being in engagement with the brake pad member to effect movement thereof;
a brake actuating structure configured to be manually movable and having a wedge member thereon, the wedge member being in engagement with the distal end portion of the lever arm member to effect pivotal movement thereof upon manual displacement of the brake actuating structure and thereby effect movement of the brake pad member relative to the friction member.

14. A brake system according to claim 13, further comprising a pair of brake pad member movable into and out of frictional engagement with the friction member.

15. A brake system according to claim 14, wherein the friction member is a brake disk having a pair of opposing outwardly facing frictional surface thereon, the pair of brake pad members being disposed on respective sides of the brake disk to engage respective frictional surfaces thereof.

16. A brake system according to claim 15, wherein the brake system includes a caliper assembly within which the brake pad members are movably mounted.

17. A brake system according to claim 16, wherein the brake system includes a pair of lever arm members, each of the lever arm members being pivotably mounted to the caliper assembly and each of the lever arm members having proximal end portions in engagement with respective brake pad members and distal end portions opposite the proximal end portions.

18. A brake system according to claim 17, wherein the wedge member is disposed between the distal end portions of the pair of lever arm members.

19. A brake system according to claim 18, wherein each of the distal end portions defines an inclined slide surface thereon that abut respective inclined wedge surfaces defined on the wedge member such that, as the wedge member advances and retreats along the distal end portions, the distal end portions are pivotably moved outwardly and inwardly, respectively, thereby moving the proximal end portions and the brake pad members inwardly and outwardly, respectively.

20. A brake system according to claim 19, wherein the power unit includes a substantially rigid housing structure.

21. A brake system according to claim 20, wherein the brake actuating structure is pivotably mounted to the housing structure.

22. A brake system according to claim 21, wherein the brake actuating structure includes a brake pedal attached thereto to allow manual manipulation of the brake actuating structure by a user's foot.

23. A brake system according to claim 21, wherein the brake actuating structure has coupled thereto a cable assembly coupled to a hand brake assembly to allow manual manipulation of the brake actuating structure by a user's hand.

24. A brake system according to claim 20, wherein the brake caliper assembly includes a housing thereof fixedly coupled to the housing of the power unit via a spacer member disposed between and fixedly connected to the housing of the power unit and housing of the caliper assembly.

25. A power unit for an ATV including a frame structure, the power unit comprising:
an engine;
a housing configured to couple to the frame of the ATV;
an output shaft rotatably coupled to the engine;
a friction member fixedly coupled to the output shaft to rotate therewith, the friction member defining a frictional surface thereon;
a brake pad member movable relative to the friction member into and out of frictional engagement with the frictional surface to generate the braking force; and
a lever arm member pivotably mounted to the power unit between proximal and distal end portions of the lever arm member, the proximal end portion being in engagement with the brake pad member to effect movement thereof.

26. A brake system according to claim 25, further comprising a brake actuating structure configured to be manually movable and having a wedge member thereon, the wedge member being in engagement with the distal end portion of the lever arm member to effect pivotal movement thereof upon manual displacement of the brake actuating structure and thereby effect movement of the brake pad member relative to the friction member.

27. An ATV comprising:
a frame;
a straddle seat mounted to the frame; and
the power unit of claim 25.
